(19) United States
(12) Patent Application Publication
(10) Pub. No.: US 2003/0204472 A1
(43) Pub. Date: Oct. 30, 2003

(54) Content delivering system

(75) Inventor: Junichi Yamagishi, Taito-ku (JP)

Correspondence Address: JORDAN AND HAMBURG LLP, 122 EAST 42ND STREET, SUITE 4000, NEW YORK, NY, 10168, US

(73) Assignees: Unirec Co., Ltd., Taito-ku (JP); Junichi YAMAGISHI, Taito-ku (JP)

(21) Appl. No.: 10/423,736

(22) Filed: Apr. 25, 2003

(30) Foreign Application Priority Data
Apr. 26, 2002 (JP) P2002-126666

(51) Int. Cl. G06F 17/60

(52) U.S. Cl. 705/41

(57) ABSTRACT

A content delivering system allows easy acquisition of content upon personal authentication.

A personal computer (7) issues a content acquisition request. In response to the request, a mail delivery server (15) transmits an address of a pay site to the personal computer. A cellular phone (11) is used to access the pay site address and enter an ID number and a password for conducting registration and making a content using contract at the pay site. After the registration, the pay site prepares a personal authentication program corresponding to the ID number and password. The cellular phone is used to download the personal authentication program. If personal authentication is successfully conducted according to the personal authentication program, a content server (5) allows the personal computer 7 to acquire content. An accounting server (17) accumulates charges according to content acquired by the personal computer. The accumulated charges are equal to content charges minus commissions including a personal authentication commission.

### BACKGROUND OF THE INVENTION

1. Field of the Invention

The present invention relates to a content delivering system for delivering content.

2. Description of the Related Art

An example of a content delivering system is disclosed in Japanese Unexamined Patent Application Publication No. 2002-109395. This disclosure employs a prepaid card to collect a charge for delivered content. The disclosure also employs a credit card for the settlement.

With the prepaid card or credit card, a content provider can collect charges for delivered content.

A user, however, must purchase a new prepaid card whenever fully consuming a prepaid card in hand. This is inconvenient for the user in smoothly obtaining content.

Compared with the prepaid card, the credit card is more trouble-free because settlement with the credit card is automatic once the credit card number is registered for content delivery. Registering the credit card number through the Internet, however, is insecure. In the first place, any user having no credit card is unable to obtain content.

There is a necessity of providing a content delivering system that satisfies user's requirement for smooth acquisition of content such as music and motion pictures.

### SUMMARY OF THE INVENTION

An object of the present invention is to provide a content delivering system capable of conducting personal authentication and allowing content acquisition without prepaid cards or credit cards.

In order to accomplish the object, a first aspect of the present invention provides a content delivering system including a content delivery unit for delivering stored content through a network, a content acquisition unit for acquiring the content from the content delivery unit through the network, a mobile communication network including a pay site that receives personal information for registration and prepares personal authentication data, a mobile communication terminal having an address and connectable to the network through the mobile communication network, a mail delivery unit for delivering an address of the pay site, and an accounting unit for accumulating charges according to acquisition of content by the content acquisition unit. The mail delivery unit transmits the address of the pay site to the content acquisition unit in response to a content acquisition request from the content acquisition unit. The mobile communication terminal is used to access the pay site and enter the personal information for conducting registration and making a content using contract at the pay site. Upon the registration, the pay site prepares the personal authentication data corresponding to the personal information. The mobile communication terminal obtains the personal authentication data. The content delivery unit allows the content acquisition unit to acquire the content if personal authentication is successfully conducted according to the personal authentication data.

A second aspect of the present invention characterizes the system of the first aspect such that the accumulation of charges is carried out for or in consideration of a commission for preparing the personal authentication data.

A third aspect of the present invention characterizes the system of any one of the first and second aspects such that the personal authentication data is a personal authentication program prepared according to the personal information, the mobile communication terminal generates, from the personal authentication program, a signal corresponding to the personal information, and the content acquisition unit includes a read unit to read the generated signal.

According to the first aspect, the mail delivery unit transmits the address of the pay site to the content acquisition unit in response to a content acquisition request from the content acquisition unit. The mobile communication terminal is used to access the pay site address, enter the personal information for registration for the pay site, and make a content using contract at the pay site. According to the registration, the pay site prepares the personal authentication data corresponding to the personal information.

The mobile communication terminal is used to obtain the personal authentication data. If personal authentication is successfully conducted with the use of the personal authentication data, the content delivery unit allows the content acquisition unit to acquire the content.

The accounting unit accumulates charges according to acquisition of the content by the content acquisition unit.

Based on the content using contract and the charges accumulated for content delivered after personal authentication, billing to a user for content acquired upon personal authentication is smoothly carried out and the user can satisfactorily obtain content.

Personal authentication is conducted according to the personal authentication data transferred through the mobile communication terminal without purchasing a prepaid card or transmitting a credit card number, thereby ensuring security.

In addition to the effects of the first aspect, the second aspect provides an effect that the accumulation of charges is carried out for or in consideration of a commission for preparing the personal authentication data. Personal authentication is simply achievable with the use of the mobile communication terminal without prepaid cards or credit cards to thereby promote the acquisition of content.

In addition to the effects of the first and second aspects, the third aspect provides effects that the personal authentication data is a personal authentication program prepared according to the personal information, the mobile communication terminal generates, from the personal authentication program, a signal corresponding to the personal information, and the content acquisition unit includes a read unit to read the generated signal. Based on the personal authentication program, the mobile communication terminal generates a signal corresponding to the personal information. The read unit receives and reads the signal representative of the personal information. With the use of the personal authentication program, the acquisition of content becomes easier

### BRIEF DESCRIPTION OF THE DRAWINGS

FIG. 1 is a schematic view showing a content delivering system according to an embodiment of the present invention;

FIG. 2 is a block diagram showing a signal read configuration according to an embodiment of the present invention;

FIG. 3 is a model showing an example of a personal authentication data string according to an embodiment of the present invention;

FIG. 4 is a flowchart showing a user registration process according to an embodiment of the present invention;

FIG. 5 is a flowchart showing a content acquisition process according to an embodiment of the present invention; and

FIG. 6 is a flowchart showing a billing-to-payment process according to an embodiment of the present invention.

### DETAILED DESCRIPTION OF EMBODIMENTS

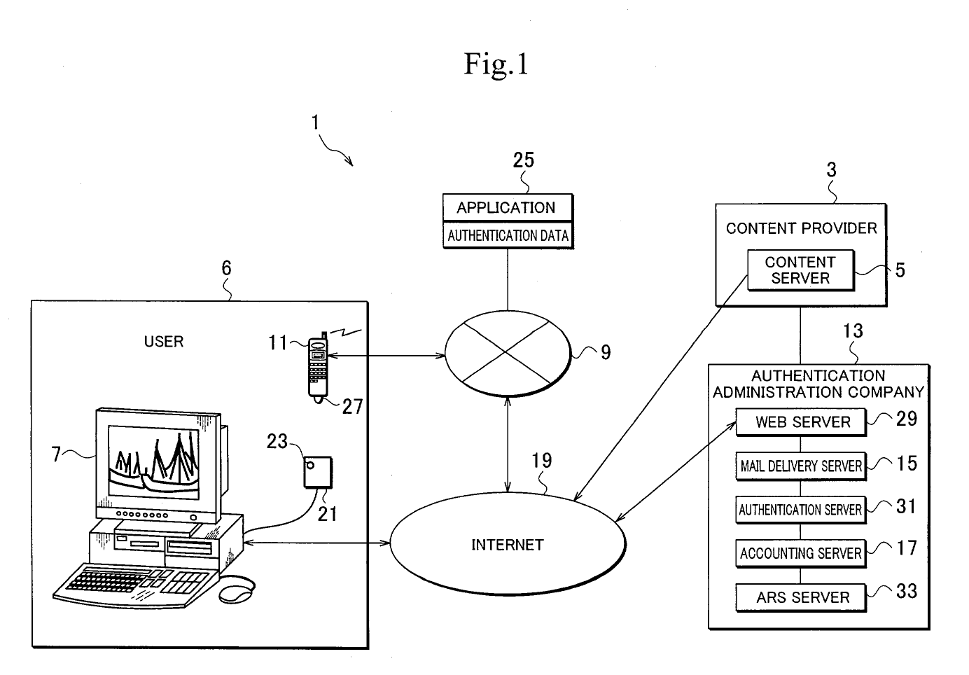

FIG. 1 is a schematic view showing a content delivering system according to an embodiment of the present invention. The content delivering system 1 includes a content provider 3 serving as content delivery means, a content server 5 belonging to the content provider 3, a desktop personal computer (PC) 7 serving as content acquisition means belonging to a user 6, a cellular phone network 9 or a mobile communication network, a cellular phone 11 or a mobile communication terminal belonging to the user 6, a mail delivery server 15 serving as mail delivery means belonging to a authentication administration company 13, and an accounting server 17 serving as accounting means belonging to the authentication administration company 13.

The content server 5 stores content and is connected to a network to deliver the content through the network that may be the Internet 19. The content may include music, motion pictures, and the like. The content provider 3 connects with the authentication administration company 13 through, for example, a dedicated line. Although there is one content provider 3 in FIG. 1, there may be a plurality of content providers which may optionally be selected or combined when practicing the present invention.

The personal computer 7 is connected to the Internet 19, to obtain content from the content server 5. The personal computer 7 has an optical reader 21. The optical reader 21 has a warning lamp 23 which may flash when personal authentication is unsuccessful.

The cellular phone network 9 may be an i-mode network of Docomo, an EZ network of AU, a J-Sky network of J-Phone, and the like. Although there is only one cellular phone network 9 in FIG. 1, reality is that the i-mode, EZ, and J-Sky networks coexist. These networks may optionally be selected or combined when practicing the present invention.

The i-mode network, for example, includes pay sites that allow users to register. At a pay site, a user enters personal information such as an ID number and a password for conducting registration, and upon the registration, the pay site prepares personal authentication data 25 from the entered personal information. The personal authentication data 25 is, for example, a Java (registered trademark) application program including authentication data generated from the entered ID number and password. According to this embodiment, the personal authentication program is downloaded from a Java application site accessed from the pay site.

The cellular phone 11 has an e-mail address and is connectable to the Internet 19 through the cellular phone network 9. The cellular phone 11 has a browser that can download and execute the Java application program. Based on the program, the cellular phone 11 outputs a signal representative of the personal information. This signal may be any one of or any combination of light, sound, and vibration signals.

According to this embodiment, the signal is a light signal emitted from a light emitter 27 of the cellular phone 11. The cellular phone 11 may have no light emitter 27. In this case, a backlight of the cellular phone 11 may be turned on and off, or a monochrome screen of the cellular phone 11 may repeatedly be inverted, to emit a light signal. If the signal is a sound signal, speaker sound of the cellular phone 11 is controlled to generate the sound signal. If the signal is a vibration signal, a vibrator of the cellular phone 11 is controlled to generate the vibration signal.

In this way, light, sound, or vibration used for notifying a cellular phone user of an incoming call can be used to generate the personal authentication signal. This technique eliminates the need of an output unit dedicated for personal authentication, enables a standard cellular phone to be used for personal authentication, and simplifies the structure of the system.

The optical reader 21 serves as read means to receive and read the light signal from the cellular phone 11. The optical reader 21 belongs to the personal computer 7. Namely, the personal computer 7 serving as content acquisition means includes signal read means. According to this embodiment, the light emitter 27 of the cellular phone 11 is inserted into the optical reader 21, which reads, with a photodiode, the light signal emitted from the light emitter 27.

If the signal is a sound signal, the optical reader 21 is replaced with a microphone to receive the sound signal. If the signal is a vibration signal, the optical reader 21 is replaced with a pressure sensor to detect the vibration signal. If the signal is an optional combination of light, sound, and vibration signals, the optical reader 21 is replaced with a proper combination of the photodiode, microphone, and pressure sensor. Based on the personal authentication program including the authentication data, an authentication code may be displayed on the cellular phone 11, and the user may enter the authentication code into the personal computer 7 with a keyboard.

The mail delivery server 15 stores the addresses of pay sites and is connectable to the Internet 19. The accounting server 17 accumulates charges according to acquisition of content by the personal computer 7. The details of this will be explained later. The authentication administration company 13 has the mail delivery server 15, the accounting server 17, a web server 29, an authentication server 31, an ARS server 33, and the like.

The web server 29 allows the authentication administration company 13 to operate on the Internet 19. The authentication server 31 authenticates an individual according to a signal read by the optical reader 21 or an authentication code entered into the personal computer 7 and transferred to the authentication server 31. The ARS server 33 carries out a collide recognition operation.

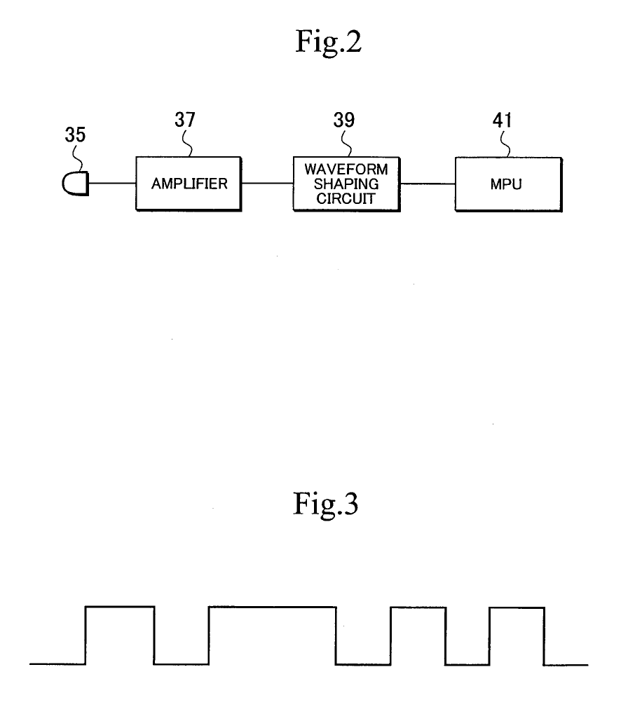

FIG. 2 is a block diagram showing a configuration of the optical reader 21. The optical reader 21 has the photodiode 35. An output signal of the photodiode 35 is passed through an amplifier 37 and a waveform shaping circuit 39 to an MPU 41 of the personal computer 7.

FIG. 3 shows an example of a personal authentication data string. The personal authentication data 25 generates a light signal representative of a serial pulse string of, for example, “54356.” The light signal is received by the photodiode 35, is passed through the amplifier 37, waveform shaping circuit 39, and MPU 41, and is provided as the data string of FIG. 3.

With the above-mentioned arrangement, the authentication administration company 13 conducts registration with a management company of the cellular phone network 9 so that the cellular phone network management company may bill the user 6 for charges of content acquired by the user 6. For example, the registration is made for a fixed monthly charge for content that is provided by the content provider 3 and is used by the user 6. Different content providers may offer an equal fixed monthly charge, different monthly charges, or pay-per-view charges.

To acquire content, the user 6 connects the personal computer 7 to the Internet 19 and requests the content server 5 for the content. Then, the user 6 on the personal computer 7 is prompted to select a content delivering system. If the user 6 selects the content delivering system of this embodiment, the personal computer 7 prompts the user 6 to enter the e-mail address of the cellular phone 11. The user 6 enters the e-mail address into the personal computer 7. The entered address is transferred from the content provider 3 to the authentication administration company 13, which transmits an e-mail containing the address of a pay site existing in the cellular phone network 9 to the personal computer 7.

According to the pay site address transmitted to the personal computer 7, the user 6 employs the cellular phone 11 to access the pay site. At the pay site, the user 6 employs the cellular phone 11 to enter personal information such as an ID number and a password and make a content using contract at the pay site. After making the content using contract, the pay site prepares a personal authentication program containing authentication data based on the ID number and password. The registered personal information is transmitted to the authentication server 31 of the authentication administration company 13.

The user 6 employs the cellular phone 11 to download the personal authentication program. The user 6 inserts the cellular phone 11 into the optical reader 21, which reads a light signal generated by the cellular phone 11 according to the personal authentication program and emitted from the light emitter 27. As shown in FIG. 2, the light signal is received by the photodiode 35, and the personal computer 7 provides a personal authentication data string accordingly. If there is no optical reader 21, the cellular phone 11 displays an authentication code generated from the personal authentication program, and the user 6 sees the authentication code and enters it into the personal computer 7 with the keyboard.

The personal computer 7 transmits the read signal or the entered data to the web server 29 of the authentication administration company 13, which transfers the data to the authentication server 31. The authentication server 31 authenticates the user 6 according to the received data and registered personal information. If the user 6 is successfully authenticated, the authentication administration company 13 sends the successful authentication result to the content provider 3 and carries out a charge accumulating action in the accounting server 17.

This charge accumulating action corresponds to a billing action carried out at the pay site to the user 6 for content acquired by the user 6. At the pay site, a fixed monthly charge is set for the content provider 3. The management company of the cellular phone network 9 bills the user 6 who acquires content through the pay site for the fixed monthly charge. The authentication administration company 13 obtains a communication carrier from the management company of the cellular phone network 9 and accumulates charges by deducting, from the billed amount to the user 6, a commission of several percents of the management company of the cellular phone network 9 and a commission of several percents of the authentication administration company 13. The commission of the authentication administration company 13 is a commission for preparing a personal authentication program and occurs when the personal authentication program is downloaded through the cellular phone 11 to conduct personal authentication. Namely, the accounting server 17 accumulates charges in consideration of the commission for preparing a personal authentication program. This commission may directly be accumulated when the personal authentication program is downloaded through the cellular phone 11 without regard to a personal authentication result.

According to a successful authentication result from the authentication administration company 13, the content provider 3 delivers content from the content server 5 to the personal computer 7. The user 6 acquires the content through the personal computer 7.

If the personal authentication at the authentication server 31 is unsuccessful, the personal computer 7 receives an unsuccessful authentication result and flashes the lamp 23 of the optical reader 21 to inform the user 6 of the unsuccessful authentication.

The management company of the cellular phone network 9 collectively bills the user 6 for the fixed monthly charge for the pay site and a telephone charge.

The user 6 pays the billed amount to the management company of the cellular phone network 9, which deducts the commission of several percents of its own from the paid amount and pays the balance to the authentication administration company 13. This payment is achieved, for example, every month according to a contract made beforehand between the management company of the cellular phone network 9 and the authentication administration company 13. The contract stipulates, for example, a monthly charge for content delivered by the content provider 3 and a commitment of the payment mentioned above. The amount of the charges accumulated at the accounting server 17 of the authentication administration company 13 is equal to an amount calculated by deducting, from the amount paid by the user 6, the commission of several percents of the management company of the cellular phone network 9 and the commission of several percents of the authentication administration company 13, and therefore, the authentication administration company 13 pays this amount to the content provider 3. The payment from the authentication administration company 13 to the content provider 3 is carried out, for example, monthly based on a contract made beforehand between the authentication administration company 13 and the content provider 3. This contract stipulates, for example, a monthly charge for content delivered by the content provider 3 and a commitment of the payment mentioned above.

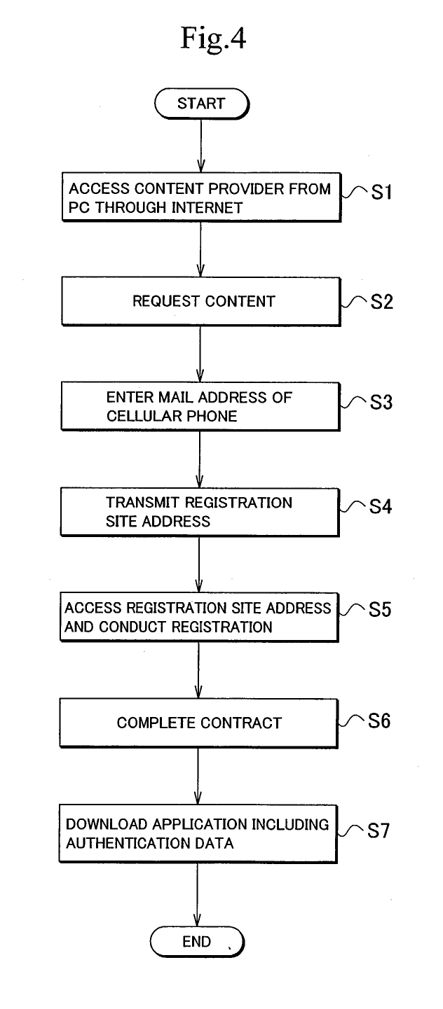

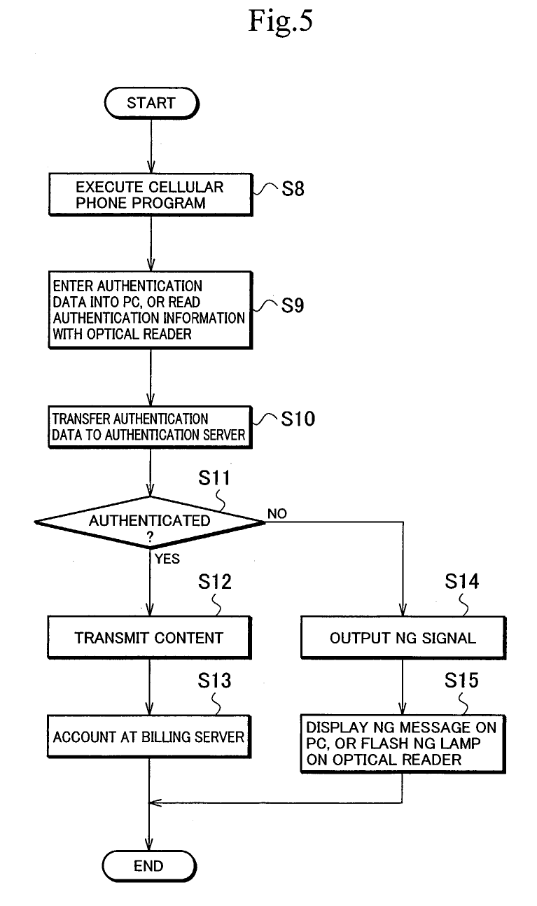

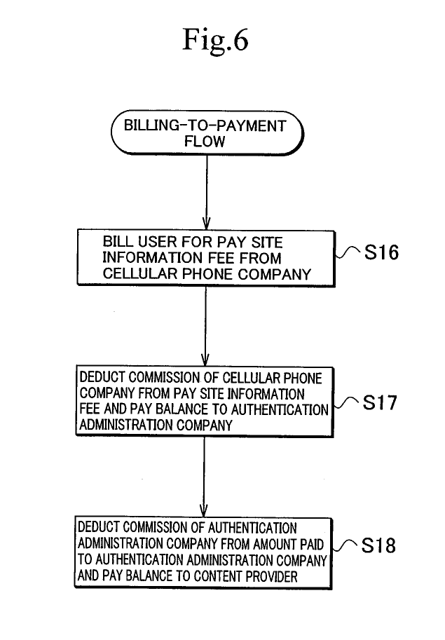

FIGS. 4 to 6 are flowcharts showing processes according to the present invention, in which FIG. 4 shows a user registration process, FIG. 5 a content acquisition process, and FIG. 6 a billing-to-payment process.

The user registration process of FIG. 4 will be explained. Step S1 accesses the content provider 3 from the personal computer 7 through the Internet 19. Namely, the user 6 manipulates the personal computer 7 to access the Internet 19. In step S2, the user 6 employs the personal computer 7 to send a content acquisition request.

Step S3 enters the mail address of the cellular phone 11. Namely, in response to the content acquisition request, the content provider 3 makes the personal computer 7 prompt the user 6 to enter the e-mail address of the cellular phone 11. The user 6 enters the e-mail address into the personal computer 7.

Step S4 transmits a registration site address. Namely, the content provider 3 receives the e-mail address and transfers the same to the authentication administration company 13. The mail delivery server 15 of the authentication administration company 13 transmits an address of a pay site existing in the cellular phone network 9 to the personal computer 7, which displays the pay site address.

Step S5 accesses the pay site address and conducts registration. Namely, the user 6 sees the pay site address displayed on the personal computer 7 and employs the cellular phone 11 to access the pay site address in the cellular phone network 9. At the pay site, the user 6 enters personal information including an ID number and a password and conducts registration. After the registration, the pay site prepares a program including personal authentication data.

Step S6 completes a contract. Namely, after the registration of step S5, step S6 completes a content using contract at the pay site. As a result, the management company of the cellular phone network 9 is allowed to bill the user 6 for a telephone charge as well as a fixed monthly charge for the use of the pay site and content acquisition.

Step S7 downloads application including authentication data. Namely, the user 6 employs the cellular phone 11 to download the personal authentication data (program) 25 prepared at the pay site. After the downloading of the personal authentication program into the cellular phone 11, the content acquisition process of FIG. 5 starts.

In FIG. 5, step S8 executes the cellular phone program. Namely, the light emitter 27 generates, according to the downloaded program, an optical signal representative of authentication information. Alternatively, the cellular phone 11 displays an authentication code according to the downloaded program.

Step S9 enters authentication data into the personal computer 7 by reading authentication information with or without the optical reader 21. Namely, the photodiode 35 of the optical reader 21 reads the optical signal representative of the authentication information provided by the light emitter 27. Alternatively, the user 6 may enter the authentication code displayed on the cellular phone 11 into the personal computer 7.

Step S10 transfers the entered data to the authentication server 31 of the authentication administration company 13. Namely, the personal computer 7 transfers the entered personal authentication data to the authentication server 31 through the web server 29 of the authentication administration company 13.

Step S11 determines whether or not authentication is successful. This step is carried out by the authentication server 31. If personal authentication is successful (YES), step S12 is carried out to transmit content. Namely, the authentication administration company 13 transmits a successful authentication result to the content provider 3, and the content server 5 of the content provider 3 delivers content to the personal computer 7. As a result, the user 6 can obtain the delivered content from the personal computer 7.

After transmitting the successful authentication result from the authentication administration company 13 to the content provider 3, step S13 is carried out. Step S13 is a accounting step at the accounting server 17 of the authentication administration company 13. Namely, the accounting server 17 subtracts, from the content charge at the pay site billed to the user 6, the commission of several percents of the cellular phone network management company and the commission of several percents of the authentication administration company 13 and accumulates the balance.

If the authentication in step S11 is unsuccessful (NO), step S14 is carried out to output an NG (no-good) signal. The NG signal is transmitted to the personal computer 7 from the authentication server 31 through the web server 29.

Thereafter, step S15 is carried out to display an NG message on the personal computer 7 or flash the warning lamp 23 of the optical reader 21. Namely, step S15 displays the NG message on the personal computer 7 or flashes the lamp 23 of the optical reader 21, to inform the user 6 that personal authentication was unsuccessful.

FIG. 6 shows the billing-to-payment process. In step S16, the management company of the cellular phone network 9 bills the user 6 for the pay site charge. This charge is a fixed monthly charge and is billed together with a cellular phone charge.

Step S17 deducts the commission of several percents of the cellular phone network management company from the pay site charge paid by the user 6 to the cellular phone network management company and pays the balance to the authentication administration company 13. In step S18, the authentication administration company 13 deducts the commission of several percents of the authentication administration company 13 from the paid balance and pays the balance to the content provider 3. As a result, the management company of the cellular phone network 9 receives the commission for the usage of the pay site, the authentication administration company 13 receives the commission for personal authentication, and the content provider 3 receives the balance as charges for delivered content.

In this way, the content delivering system according to this embodiment asks the user 6 to make a content using contract at a pay site and makes the accounting server 17 accumulate charges, so that charges including content charges and personal authentication charges may smoothly be billed to the user 6 and the user 6 may satisfactorily acquire content.

The personal authentication is achieved through the cellular phone 11 according to a personal authentication program without the purchase of prepaid cards or the transmission of credit card numbers, to thereby ensure security.

The cellular phone 11 employs the personal authentication program, to easily acquire content.

The cellular phone 11 generates, according to the personal authentication program, a personal information signal selected from the group consisting of a light signal, a sound signal, a vibration signal, and any combination of light, sound, and vibration signals. The signal is read by, for example, an optical reader, to easily acquire content.

The management company of the cellular phone network 9 bills the user 6 for charges related to content usage at the pay site, deducts the commission of several percents of the management company from an amount of money paid by the user 6 for the bill, and may directly pay the balance to the content provider 3. In this case, the authentication administration company 13 directly accumulates the commission of several percents of the authentication administration company 13 and may bill the content provider 3 for the commission, for example, every month. Alternatively, the content provider 3 obtains the accumulated result and pays an amount of money corresponding to the accumulated result to the authentication administration company 13.

What is claimed is:

1. A content delivering system comprising:
content delivery means for delivering stored content through a network;
content acquisition means for acquiring the content from the content delivery means through the network;
a mobile communication network including a pay site that receives personal information for registration and prepares personal authentication data;
a mobile communication terminal having an address and connectable to the network through the mobile communication network;
mail delivery means for delivering an address of the pay site; and
accounting means for accumulating charges according to acquisition of content by the content acquisition means,
the mail delivery means transmitting the address of the pay site to the content acquisition means in response to a content acquisition request from the content acquisition means,
the mobile communication terminal being used to access the pay site and enter the personal information for conducting registration and making a content using contract at the pay site, the pay site, upon the registration, preparing the personal authentication data corresponding to the personal information,
the mobile communication terminal being used to obtain the personal authentication data,
the content delivery means allowing the content acquisition means to acquire the content if personal authentication is successfully conducted according to the personal authentication data.

2. The system of claim 1, wherein:
the accumulation of charges is carried out for or in consideration of a commission for preparing the personal authentication data.

3. The system of any one of claims 1 and 2, wherein:
the personal authentication data is a personal authentication program prepared according to the personal information;
the mobile communication terminal generates, from the personal authentication program, a signal corresponding to the personal information; and
the content acquisition means includes read means to read the generated signal.
